(19) United States
(12) Patent Application Publication
(10) Pub. No.: US 2007/0223318 A1
(43) Pub. Date: Sep. 27, 2007

(54) Watch with generator

(75) Inventor: Pierre Nobs, Wangen (CH)

Correspondence Address: PEARNE & GORDON LLP, 1801 EAST 9TH STREET, SUITE 1200, CLEVELAND, OH, 44114-3108, US

(73) Assignee: Ventura Design on Time SA, Volketswil (CH)

(21) Appl. No.: 11/705,857

(22) Filed: Feb. 13, 2007

(30) Foreign Application Priority Data
Feb. 13, 2006 (CH) 00223/06

(51) Int. Cl. G04C 3/00; G04B 1/00

(52) U.S. Cl. 368/204

(57) ABSTRACT

Watch including an electric generator module actuated by an oscillating mass following the wearer's movements. The oscillating mass is visible behind a glass of the dial next to the time display. The watch also includes a display mode of the run reserve and of the energy balance.

### REFERENCE DATA

This patent application claims priority from Swiss patent application No. 2006CH-00223 of Feb. 13, 2006, the contents whereof are hereby incorporated by reference.

### TECHNICAL FIELD

The present invention concerns a watch provided with a generator module for transforming the kinetic energy into electric energy that can be used for powering the watch.

### RELATED ART

One knows the difficulties associated with the energy powering of electronic wristwatches. Everyone knows in particular how much the periodical replacing of the battery, performed by a specialized technician, is disagreeable and constraining for the users.

Substituting the battery requires the producer to provide openings, often watertight, in the bottom of the watch, for example to allow for the batteries to be replaced. These openings and additional parts entail additional costs for the watch.

Several watches including autonomous electric energy generators have been proposed, for example in patents U.S. Pat. No. 6,155,621 and EP0927917. In these watches, the generator is often actuated by an oscillating mass similar to the rewinding mass of automatic mechanical watches and charges an accumulator, which powers a quartz watch movement of known type.

This type of watch, however, has a certain number of disadvantages, notably:

a greater thickness compared with a traditional quartz watch;

the difficulty of checking at any time whether the watch is properly charged and of knowing the charge state of the accumulator;

if the watch is not worn during a prolonged period of time, the accumulator can discharge completely and this can cause the watch to start only with difficulty.

### BRIEF SUMMARY OF THE INVENTION

The present invention thus aims to solve these difficulties and to propose a watch powered by a generator that is free from the aforementioned disadvantages.

Another aim of the invention is to propose a watch wherein the charge state can be checked easily.

Another aim of the invention is to propose a watch having a simpler design and construction.

These aims are achieved by the object of the independent claim and notably by a wristwatch having:
an oscillating mass free to turn around a fixed rotation axis relatively to the watch;
an electric generator driven by the rotation of the oscillating mass;
an element for storing the electric energy, connected electrically at the output of the electric generator;
a movement, powered by the storing element, said time-keeper having a display module visible on the face of the watch;

characterized in that said oscillating mass is visible on the face's side of the watch.

In the present application, the “face” side of the watch refers to the upper side, where the time indicators are located.

### SHORT DESCRIPTION OF THE FIGURES

Examples of embodiments of the invention are indicated in the description illustrated by the attached figures in which:

FIG. 1 shows the outer aspect of a watch according to one aspect of the invention;

FIG. 2 illustrates diagrammatically and in a non-limiting way, a possible arrangement of the inner elements of a watch according to the invention;

FIG. 3 exemplifies diagrammatically the relationships between the elements of the inventive watch.

### EXAMPLES OF EMBODIMENTS OF THE INVENTION

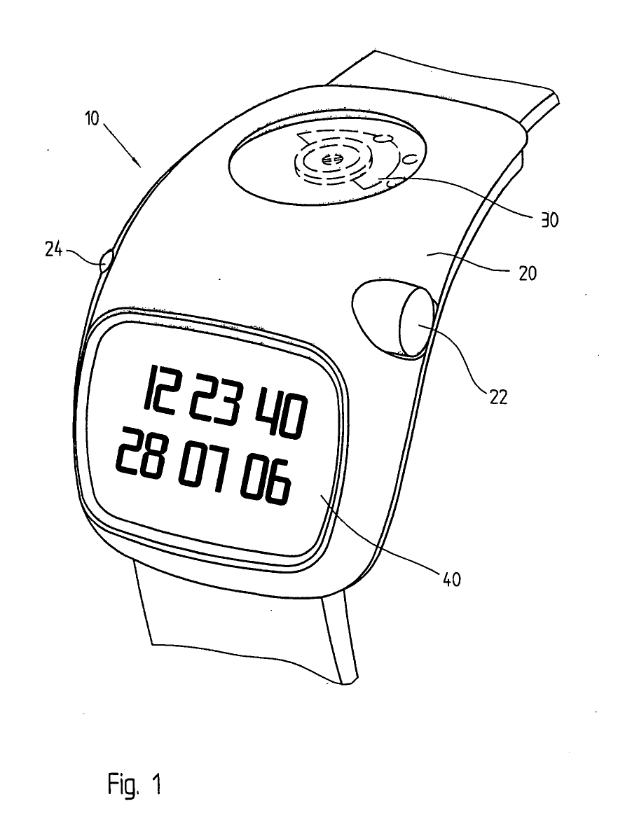

FIG. 1 shows a watch 10 according to the invention having, in a case 20, a digital quartz watch movement, with a numeric display device visible through the glass 40.

The case 20 is for example metallic and of cambered shape to follow the curve of the wearer's wrist, as represented in the figures. One will however understand that the invention is not limited to these characteristics and that one could also consider a cambered or flat-bottomed case, of ceramic, plastic, composite or any other suitable material.

The display device or dial preferably has two lines of alpha-numeric characters and/or of any other graphic symbols. One line, for example the upper line, is preferably intended for displaying the time whilst the other display line is used for displaying another function of the watch, for example a function of chronograph, alarm, time zone, calendar, thermometer, altimeter, barometer, short message, calculator, telephone, diary or any other function.

Furthermore, the present invention also includes variant embodiments with different display devices, for example analog hand displays or even mixed analog-numeric displays.

The watch has input and control devices, for example the push button 24 on the middle, to allow the user to check the watch's functioning, to activate the different functions and, in conventional fashion, to set the time.

Preferably, the watch also has on the middle, and partially occupying the face, a control roll of the type “easySkroll®” 22, that can be turned and pressed by the tip of a finger. This device is described in patent application EP1422583 in the name of the applicant that is hereby incorporated by reference.

Other input devices are also possible and included in the frame of the present invention. One will cite by way of non-exhaustive examples of input devices: buttons on the face, crowns of classical type, magnetic contacts or a tactile glass.

The glass 30 allows an oscillating mass to be visible, free to turn around a fixed rotation axis, driving an electric generator, not visible in FIG. 1, that ensures the powering of the movement, as will be seen later. According to the example, the glass 30 is separated from the glass 40 of the display. This disposition allows the electric elements between the generator and the display to be hidden under portions of the middle. One could however also execute the invention with a single glass, curved or plane, of appropriate shape, that protects both the display and the generator module, comprising the oscillating mass and the electric generator.

Depending on the shape chosen for the oscillating mass, the generator that, in one embodiment of the invention, is located under the latter, can also be partially or totally visible.

The visibility of the oscillating mass adds a dynamic and esthetically interesting aspect to the watch. Furthermore, the user can also appreciate directly, by observing this mass, whether the watch has been charged in an efficient manner.

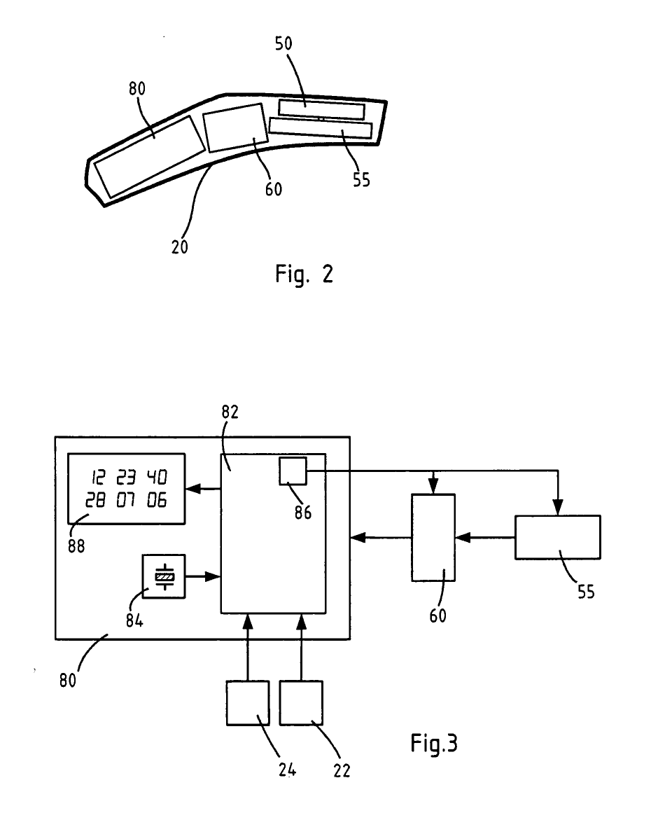

With reference to FIG. 2, we will now describe a possible arrangement of the elements of the inventive watch. The watch includes an oscillating mass 50, free to turn following the wearer's movements, around its central axis. The mass 50 drives, through a transmission 8 not represented), the generator 55.

According to one embodiment (not represented), the generator module includes a spring, tensed by the movement of the oscillating mass, and an automatic coupling device, for actuating the generator when the tension of the spring exceeds a predetermined threshold. Once the spring has been released, the generator stops and this cycle, which can be repeated several times per minute if the wearer is very active, starts again.

This variant embodiment is advantageous since it allows the generator to turn very quickly, thus reducing part of the energy losses that occur if it turns too slowly. On can however drive the generator 55 directly by the oscillating mass 50 having a synchronous transmission with suitable reduction ratio, always engaged.

The generator 55 is for example a micro-alternator with permanent magnet rotor, or any other known electric generator. The electric output of the generator 55 is directed towards the electric storing module 60 that includes, in one embodiment a rechargeable accumulator and a charging electronic circuit that transforms for example the alternating current coming from the generator into a continuous current adapted for charging the accumulator.

The accumulator will for example be a Li-ion, Li-Poly or NiMH accumulator, a super-capacitor or any other accumulator, depending on circumstances.

The movement 80 is a quartz movement with numeric display, for example, powered by the energy stored in the storing module 60.

According to a variant embodiment (not represented), the watch has a crown that allows to turn the generator manually, through an appropriate transmission, and thus to store in the module 60 a sufficient charge for starting the watch, for example.

One can observe that the three elements of the watch: the generator module comprising the oscillating mass 50, the generator 55 and the transmission, the storing module 60 as well as the movement 80, are mechanically independent from one another and require only few electric interconnections to ensure the watch's operation.

The display module 88 and the oscillating mass 50 are arranged side-by-side and more or less on the same level. This device allows the thickness of the watch to be reduced and an esthetically interesting result to be achieved. Advantageously, the movement 80 and the generator module, including the oscillating mass 50 and the generator 55, are assembled in the case 20 in an independent and separate manner. In the illustrated embodiment, the oscillating mass 50 and the generator 55 are superimposed, parallel to one another, but not parallel to the plane of the movement 80 and to its plate. Furthermore, as can be seen in particular in FIG. 2, the storing module 60 is parallel neither to the movement's plate nor to the generator. This advantageous arrangement allows the three elements to be placed in juxtaposition along an arc of circle following the shape of the wrist.

It is however also possible to use by way of storing module a storing element occupying the lodging provided to this effect for the battery in the watch movement.

Thanks to these unique characteristics of separation between the generator module and the movement, the construction and design of the watch turn out to be easier than in the case of a traditional construction on plate. The watch's elements can be placed with the greatest freedom and it is possible to achieve a rational and economical construction that uses the available volume in optimum fashion.

Furthermore, the generator module with its oscillating mass can be placed next to an existing movement in the watch case. The movement can be constituted by an existing electronic quartz movement, available at low cost, and capable of functioning without the generator module with an adaptation of the software, if necessary. The only material modifications to be made to this existing movement to extend its run reserve consist in connecting it electrically to the generator module and possibly replacing the battery by a rechargeable battery.

With reference to FIG. 3, the movement 80 includes a control unit 82, for example a microprocessor or a dedicated ASIC logical circuit, or a FPGA or equivalent programmable logic integrated circuit, whose operating rate is rigorously set by a quartz oscillator 84. The control unit is powered with energy by the storing module 60 and receives commands from the input devices 22 and 24 of the watch, to activate for example the different functions of the watch and control the display 88 in a suitable manner.

Preferably, the control device includes an energy monitoring module 86 that checks the charge state of the battery of the storing module 60 as well as the power supplied by the generator 55 and consumed by the movement 80. The monitoring module can be for example a dedicated electronic circuit or a software module included in the micro-program of the controller 82. It can also be partly or totally included in the storing module 60.

The charge state of the battery can be achieved from its power and its temperature, in known manner, or by temporal integration of the charge and discharge currents, and of the spontaneous discharge of the battery. The charge state of the battery will preferably be obtained by a smart battery management system (Smart Battery System) that integrates optimally the available electric, heat and historical data available to reach a reliable determining of the charge state.

According to a variant embodiment of the invention, the energy monitoring module ensures the optimum management of the watch's consumption and can, if the battery's charge falls beneath a predetermined level, for example activate one or several low-consumption modes, for example by making inactive non-essential functions of the watch that require considerable power. As examples of non-essential but high-consumption functions one can mention the lighting-up of the display and the ringing.

Optionally, a low-consumption mode can reduce the power consumed by these functions without however deactivating them totally. It would for example be possible to reduce the intensity of the lighting and limit the volume and duration of the ringing.

On the other hand, a low-consumption mode could also include deactivating all the interactive functions and the display. In this case, the watch would restrict itself, in the low-consumption mode, to keeping the time internally until the storing module 60 reaches a sufficient charge level.

Finally, if the remaining charge is no longer compatible with a regular running of the movement, for example, a low-consumption mode can include totally inactivating the movement 80 and/or displaying a discharge indication.

According to one embodiment, one or several low-consumption modes can be activated at the wearer's initiative, for example by actuating one of the input devices 22, 24.

According to a variant embodiment of the invention, activating a low-consumption mode can derive from an evaluation of other parameters than the battery charge state. A low-consumption mode can be activated for example when the average generated power is low or zero during a rather long time interval, which indicates that the watch is not worn.

According to another aspect of the invention, the watch provides an energy balance display in which the information concerning the charge state and/or the generated and consumed power, available to the monitoring module 86, are presented on the display 88.

Preferably, the battery charge state is converted into hours of running autonomy, based on a prevision of average consumption for example. In this manner, it is possible to display numerically or graphically the watch's instantaneous run reserve, i.e. the watch's autonomy in the absence of re-charging by the generator 55. Alternatively, on can display, numerically or graphically, the battery charge simply in the form of a maximum charge percentage.

The displaying of the generated and consumed power also allows the user to judge the watch's autonomy. One will preferably not display the instantaneous power, highly variable, but an average power computed on an adequate temporal basis, for example several hours.

1. Watch including:
an oscillating mass free to turn around a fixed rotation axis relatively to the watch;
an electric generator driven in rotation by the oscillating mass;
an electric energy storing element, connected electrically at the output of the electric generator;
a movement powered by the storing element, said movement including a display module visible on the face of the watch;
characterized in that said oscillating mass is visible on the face side of the watch.

2. The watch of claim 1, wherein the oscillating mass is situated next to and more or less on the same level as the display module.

3. The watch of claim 1, wherein the oscillating mass drives the generator through a mechanical coupling that is always engaged.

4. The watch of claim 1, including a spring, tensed by the movement of the oscillating mass, and a coupling device, for actuating the generator when the tension of the spring exceeds a predetermined threshold.

5. The watch of claim 1, characterized in that said movement includes an electronic quartz oscillator and in that said display module is a numeric display module.

6. The watch of claim 5, characterized in that said display module includes two lines of alpha-numeric and/or graphic characters.

7. The watch of claim 1, characterized in that said generator and said oscillating mass are mechanically independent of said movement.

8. The watch of claim 1, characterized in that it includes means for determining the electric power generated by the generator and the electric power consumed by the watch.

9. The watch of claim 8, characterized by an operation mode for displaying the energy balance of the storing element and/or a run reserve corresponding to the charge state of the storing element.

10. The watch of claim 8, wherein said power is an average power during a determined period of time.

11. The watch of claim 1, characterized by a low-consumption mode, wherein at least some of the functions of the watch are totally or partly deactivated.

12. The watch of claim 11, wherein said deactivated functions include the display and/or a ringing function and/or a lighting function.

13. The watch of claim 11, wherein the movement is totally inactive in the low-consumption mode.

14. The watch of claim 11, wherein the low-consumption mode can be activated by the user.

15. The watch of claim 11, wherein the low-consumption mode is activated autonomously when the charge state of the storing element is lower than a predetermined threshold.

16. The watch of claim 1, including a connection for an external energy source.

17. The watch of claim 1, including a device, for example a crown, for manually turning the generator.

18. The watch of claim 1, characterized in that said movement is mounted in the watch case independently of said oscillating mass and of said generator.
